(19) United States
(12) Patent Application Publication
(10) Pub. No.: US 2017/0293901 A1
(43) Pub. Date: Oct. 12, 2017

(54) MOBILE TRANSACTION SYSTEMS AND DEVICES

(71) Applicant: PAYPAL INC., San Jose, CA (US)

(72) Inventor: Sumit Hasmukh Savla, Milpitas, CA (US)

(21) Appl. No.: 15/092,505

(22) Filed: Apr. 6, 2016

(51) Int. Cl. G06Q 20/10; G06Q 30/02; G06Q 20/22

(52) U.S. Cl. CPC G06Q 20/102; G06Q 20/227; G06Q 30/0226

(57) ABSTRACT

Systems and methods for processing mobile transactions include determining an indication to make a payment by a user to a payee; responsive to determining the indication, identifying, from a payment account associated with the user, a plurality of payment instruments; determining a first payment instrument in the plurality of payment instruments based at least in part on a first reward associated with making at least a portion of the payment using the first payment instrument; and generating a payment instrument alert to inform the user to make the payment using the first payment instrument.

### TECHNICAL FIELD

The present disclosure relates generally to mobile payment system and devices, and in particular, to a payment system and device with transaction optimization features.

### BACKGROUND

Payment instruments such as, for example, credit cards or debit cards, have been widely used by consumers to make payments to various merchants. However, difficulties for selecting and using payment instruments for particular transactions still abound. For example, despite often carrying several payments cards, a user may always resort to a default payment card (e.g., a debit card linked to the user's primary checking account) when paying different types of merchants, even though the default payment card would not produce an optimal return (e.g., a discount associated with the use of a particular payment card) for the user in many of these transactions. This is because it is overly burdensome to a user to determine—on-the-fly—which payment instrument would produce the optimal return for a particular transaction.

Thus, there is a need for a mobile payment device, system, and method that provides for the selection of a payment instrument for a particular transaction that produces optimal payment returns without unduly burdening a user.

### BRIEF DESCRIPTION OF THE FIGURES

FIG. 1 is a schematic view illustrating an embodiment of a system for providing mobile transactions;

FIG. 2 is a schematic view illustrating an embodiment of a system for providing mobile transactions;

FIG. 3 is a is a front view illustrating an embodiment of a user device displaying a mobile transaction screen;

FIG. 4 is a is a front view illustrating an embodiment of a user device displaying a mobile transaction screen;

FIG. 5A-5B are flow charts illustrating an embodiment of a method for providing mobile transactions;

FIG. 6 is a flow chart illustrating an embodiment of a method for providing mobile transactions;

FIG. 7 is a flow chart illustrating an embodiment of a method for providing mobile transactions;

FIG. 8 is a flow chart illustrating an embodiment of a method for providing mobile transactions;

FIG. 9 is a schematic view illustrating an embodiment of a payment service system; and

FIG. 10 is a schematic view illustrating an embodiment of a user device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides mobile devices, systems, and methods for optimizing mobile transactions. In an embodiment, after detecting that a user is making a purchase at a merchant (e.g., a grocery store or a website), the systems and methods may identify which payment instruments, e.g., credit cards and debit cards, are available in the user's account. The systems and methods may determine a reward (e.g., cash back, instant discount, loyalty program points, combinations thereof, etc.) for using each payment instrument such as, for example, a VISA® debit card offering a 5% cash back for any grocery purchases, a loyalty program credit card sponsored by the grocery store, a store-issued credit card offering $5 off a $20 or more purchase, and/or other rewards known in the art. Based on the rewards offered, the systems and methods may automatically apply a particular payment instrument to a purchase. In another example, the systems and methods may also identify a user membership (e.g., a wholesale club membership, a student discount, an age discount, etc.) based on information stored in the user account, and automatically apply the membership to the purchase when the membership can reduce user payment.

The systems and methods described in the present disclosure can provide a variety of technical advantages. In some embodiments, redundant or inefficient data communications between a user device and a merchant device may be reduced. For example, perceiving that an optimal payment method has been applied, a user might not request a transaction modification after a transaction has been completed (e.g., a price match or a return and re-buy of the same merchandise with a different credit card). In some embodiments, unnecessary data processing on a user device may be reduced. For example, trusting that a user device will suggest or apply an optimal payment method according to the teachings of the present disclosure, they user need not attempt or engage in repetitive or inefficient calculations of their own on the user device. As used herein, “optimal” may be defined in various ways, such as providing the lowest cost for the transaction, maximizing points with a particular funding source, receiving a monetarily highest value benefit, such as a coupon, free item or service, voucher, and the like. In some embodiment, a user is deemed to have an optimal reward if the user will, after a transaction is completed, receive more than a predefined amount (e.g., $20) or a predefined percent (e.g., 4%) of cash back or discount as a result of using a particular payment instruction to make a portion of the payment towards the transaction.

Additional details of implementations are now described with reference to the Figures.

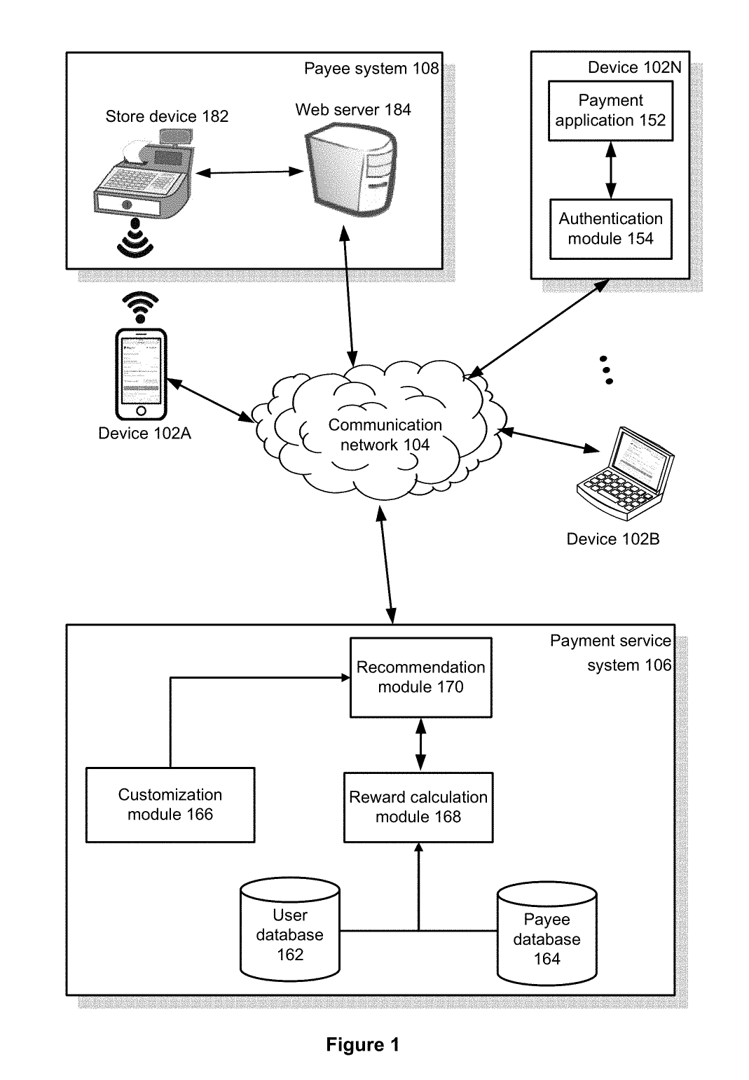

FIG. 1 is a schematic view illustrating an embodiment of a system 100 for providing mobile transactions. The system 100 may comprise or implement a plurality of servers and/or software components that operate to perform various technologies provided in the present disclosure. As illustrated in FIG. 1, the system 100 may include a plurality of devices 102 (e.g., 102A, 102B . . . 102N), a payment service system 106, and a payee system 108 in communication over a communication network 104. In an embodiment, the device 102 (also referred to as a user device in the present disclosure) may enable a user to make a payment, e.g., using one or more payment instruments identified in a payment account of the user, to the payment system 108, via the communication network 104. For example, the device 102 may include a payment application 152 for making payments through the payment service system 106. The payment application 152 may be used, for example, to initiate a payment from a user account (e.g., maintained by the payment service system 106) to a payee (e.g., a merchant) over the communication network 104. The payment application 152 may be implemented as a smartphone app or a web browser.

The user device 102 may also include an authentication application 154 which may be used to authenticate a user on the user device 102. In one embodiment, the authentication application 154 may collect credentials from a user and compare the collected credentials with previously accepted credentials to determine whether to authenticate a user on a user device. For example, the authentication application 154 may (1) collect, from a user, a password, an audio/video fingerprint, biometric data (e.g., voice, fingerprint, gesture), and/or other credential information known in the art (2) match credential information to previously accepted credential information, and (3) authenticate the user when a match occurs. The user device 102 may be implemented as a smart phone, a personal digital assistant (PDA), a laptop computer, a personal computer and/or other types of computing devices.

In some implementations, the communication network 104 interconnects one or more of the user devices 102 with each other, with the payment service system 106, and with the payee system 108. In some implementations, the communication network 104 optionally includes the Internet, one or more local area networks (LANs), one or more wide area networks (WANs), other types of networks, or a combination of such networks.

In an embodiment, the payment service system 106 enables a user to make a payment from the user device 102 to the payee system 108. For example, the payment service system 106 may include a user database 162, a payee database 164, a customization module 166, a reward calculation module 168, and a recommendation module 170, discussed in further detail below. The payment service system 106 may also include one or more payment service provider devices (which may be installed as part of a merchant device such as, for example, a store register) operated or accessible by a payment service provider, for example, PayPal Inc. of San Jose, Calif.

The user database 162 may store information identifying one or more user payment accounts 922. A user account 922 may include: one or more payment instruments 1018, one or more payment reduction offers (e.g., coupons) 102, and one or more user preferences 1022 for selecting payment instruments. The payee database 164 may store information identifying one or more payees (e.g., merchant names), payment restrictions, and payment reduction offers available from the one or more payees.

The customization module 166 may enable a user to provide preferences of payment instruments for consideration by the recommendation module 170, e.g., before or during a particular purchase. For example, a user already in credit card debt may prefer a credit card with a lower interest to that with a higher interest; a user with a low cash balance may prefer making a payment with credit (a credit card or a line of credit) to with a checking account, notwithstanding the potential interest. These user preferences may be provided to the customization module 166 as payment rules and applied by the recommendation module 170 when selecting a payment instrument. The reward calculation module 168 may determine rewards (e.g., cash backs or loyalty program points or rewards) for making a payment (or a portion thereof) with a particular payment instrument or with a payment reduction offer, or both. The recommendation module 170 may suggest to a user, or automatically select without user input, one or more payment instruments for application to a payment in accordance with user preferences provided by the customization module 166.

As discussed above, the payee system 108 may include a store device 182 (e.g., a store checkout register), a web server 184, and/or other devices operated by the merchants discussed in the present disclosure. The payee system 108 may be maintained, for example, by a conventional or on-line merchant, conventional or digital goods seller, individual seller, and/or application developer offering various products and/or services in exchange for payment to be received conventionally or over the network 104. In this regard, the payee system 108 may include a database identifying available products and/or services (e.g., collectively referred to as items in the present disclosure) which may be made available for viewing and purchase by a user.

The payee system 108 may include a checkout application, which may be configured to facilitate the purchase of items by a payer. The checkout application may be configured to accept payment information from the user through the user device 102 or through the payment service system 106 over the network 104. The payee system 108 may include merchant devices (e.g., the store device 182 and the web server 164)

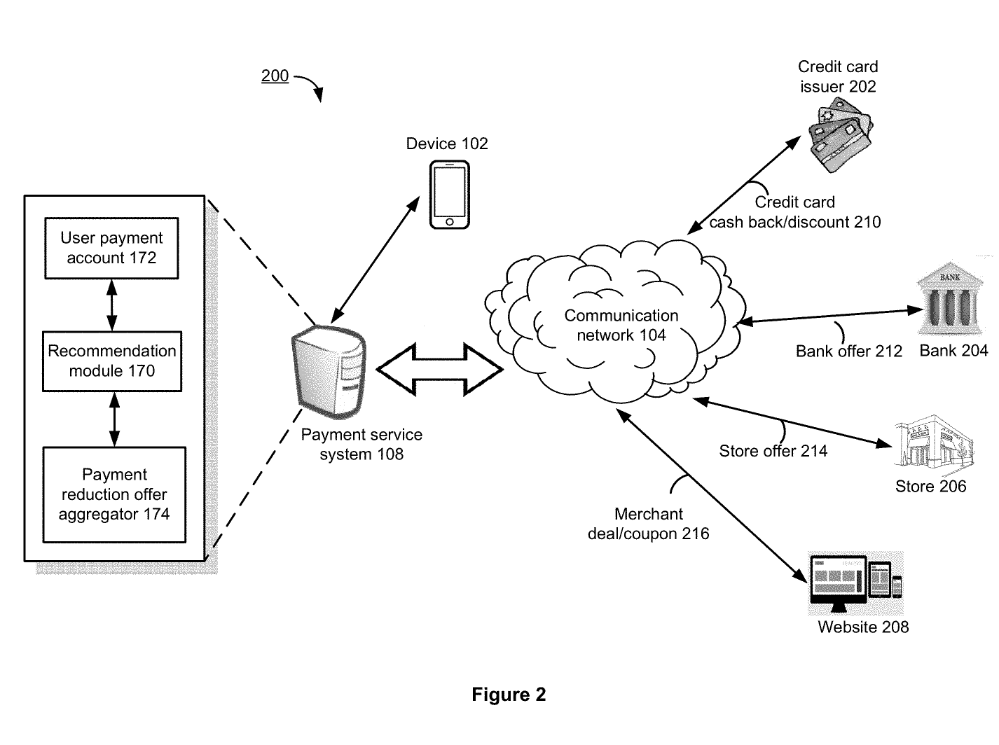

FIG. 2 is a schematic view illustrating an embodiment of a system 200 for providing mobile transactions. A shown in FIG. 2, the system 200 may include one or more payment reduction offer providers such as, for example, a credit card issuer 202, a bank 204, a store 206, and a website 208. The credit card issuer 202 may provide payment reduction offers (e.g., credit cash backs or discounts 210) for using a particular credit card (e.g., offered by the credit card issuer 202). The bank 204 may provide payment reduction offers (e.g., bank offers 212) for using a particular payment instrument offered by the bank 202 (e.g., a debit card, a checking account, and a saving account). The store 206 may provide payment reduction offers (e.g., coupons, mail-in-rebates, and store offers 214) for using a particular payment instrument (e.g., a store gift card) or for purchasing a predefined item (e.g., a gallon of milk). The website 208 may publish payment reduction offers (e.g., merchant deals or coupons 216) for purchasing one or more predefined items or for using a particular payment instrument (e.g., a laptop and a wireless speaker in a single transaction with a VISA credit card). The credit cash back or discount 210, the bank offer 212, the store offer 214, the merchant deal or discount 216, and any other forms of payment reduction offers may be made available for access by the payment service system 108 via the communication network 104.

The payment service system 108 may, in accordance with a time schedule (e.g., hourly, daily, weekly, or monthly), identify payment reduction offers from the above-identified sources. The payment service system 108 may select offers applicable to a user (e.g., the user has a bank account needed for redeeming a bank offer or the user is within a proximity from a store offering a discount) and store information identifying the selected offers in a user's account maintained by the payment service system 108.

In some implementations, the payment service system 108 may include a payment reduction offer aggregator 174, a user payment account 172, and a recommendation module 170. The user payment account 172 may store one or more payment instruments provided by a user such as, for example, a credit card, a debit card, a bank account (a checking account or a saving account), a health care flexible spending account (FSA) balance, a commuter saving balance, a home equity line of credit, a commercial line of credit, a gift card balance, or a store or merchant credit balance. Payment instruments specified in the user payment account 172 may become accessible to the device 102 in response to a successful authentication of a user on the device 102. Technologies relating to user authentication are discussed with reference to at least FIG. 1. The user payment account 172 may additionally store payment reduction offers, e.g., those the payment service system 108 previously identified from the credit issuer 202, the bank 204, the store 206, or the website 208.

The payment reduction offer aggregator 174 may identify one or more payment reduction offers applicable for a single purchase. For example, the payment service system 108 may obtain information about a user purchase (e.g., the one or more items purchased, the total payment amount, and the purchase location). Based on the purchase information, the payment reduction offer aggregator 174 may determine, for example, that a credit card cash back offer (e.g., an offer for a $5 cash back for any purchase at the user's current store location) and a store coupon (e.g., an offer for a $1 off a gallon of milk) both apply to the purchase.

The recommendation module 170 may, based on a determination provided by the payment reduction offer aggregator 174, recommend one or more payment instruments to a user. Continue with the above example, the recommendation module 170 may generate a payment instrument alert on a user device to inform the user to use the credit card under which the cash back is available and the store coupon when making a payment for the purchase. The payment instrument alert may be a visual alert, for example, a change of visual intensity (e.g., brightness or color change) of an item displayed on (or on a portion of) a display of the device 102. The payment instrument alert may also be a motion alert, e.g., one or more predefined vibrations of the device 102. The recommendation module 170 may also display information identifying the applicable offers and discounts on the user deice. In the above example, the recommendation module 170 may cause a QR code representing the store coupon to be displayed on a user's smartphone.

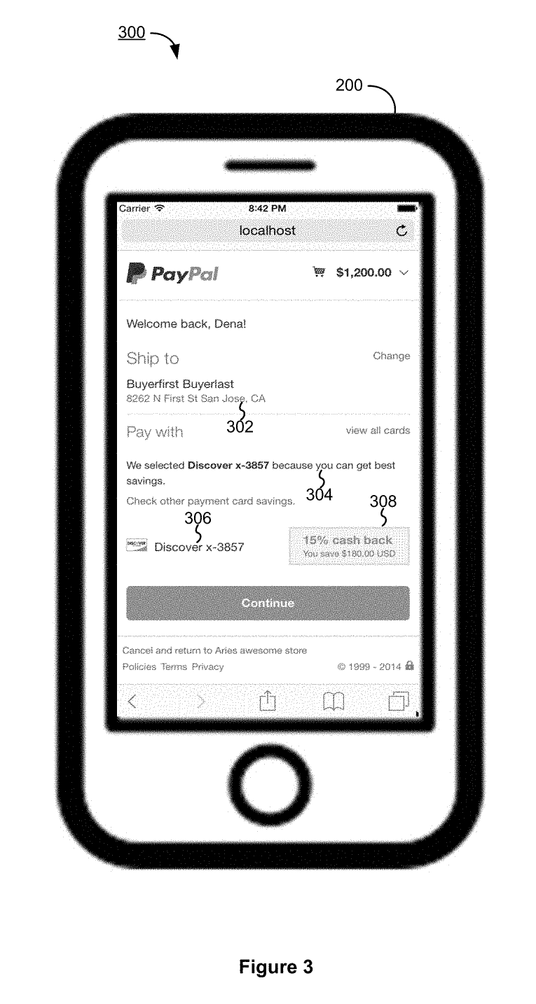

FIG. 3 is a front view illustrating a user device displaying a mobile transaction screen 300. In an embodiment, based on whether a user is at a particular stage of making a payment (e.g., providing payment information on a webpage or using a user device 200 to communicate with a merchant device), the payment service system may recommend one or more payment instruments to a user for making a particular payment. For example, as shown in FIG. 3, in response to determining that a user has provided a shipping address (302) and is about to provide payment information for an online transaction, the payment service system may automatically select a payment instrument stored in the user's account and suggest the payment instrument 306 (e.g., the Discover x-3857) to the user for completing the payment information. In some implementations, the payment service system may also identify the reward for making a payment with a suggested payment instrument. For example, as shown in FIG. 3, the payment service system may provide cash back information (308) to the user.

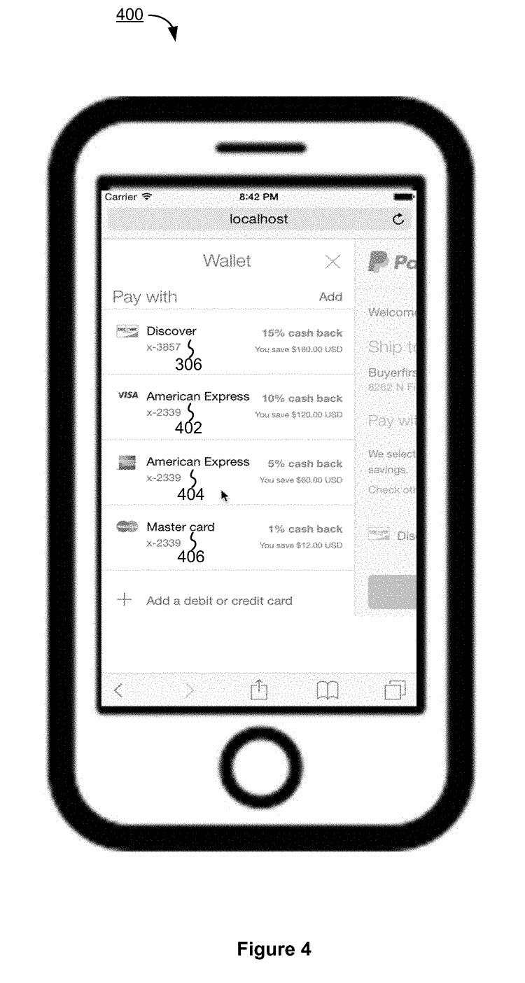

FIG. 4 is a front view illustrating a user device displaying a mobile transaction screen 400. In some implementations, in response to a user action on the screen 400, the payment service system may identify rewards for using different payment instruments stored in a user account. For example, as shown in FIG. 4, the payment service system may inform a user of different rewards for using payment instruments 306, 402, 404, and 406.

In several embodiments, the new technologies discussed above are advantageous because they enable a user to compare reward information for different payment instruments and decide which of those payment instrument(s) should be applied to a payment to maximize rewards and/or achieve a desired rewards result. This is particularly advantageous when a user may have additional knowledge about gaining rewards for using a particular payment instrument, and when assisted by the payment service system, the user is enabled to select an optimal payment method for gaining those rewards. For example, during a checkout process a user may learn (e.g., from a physical store flyer or other advertisement) that a store manager's special discount is being offered for using a store credit card. Based on this information, the user may choose a different payment instrument (other than the one suggested by the payment service system) for which a potential reward has also been determined by the payment service system, and combine that payment instrument with the manager's special discount to achieve a greater total reward.

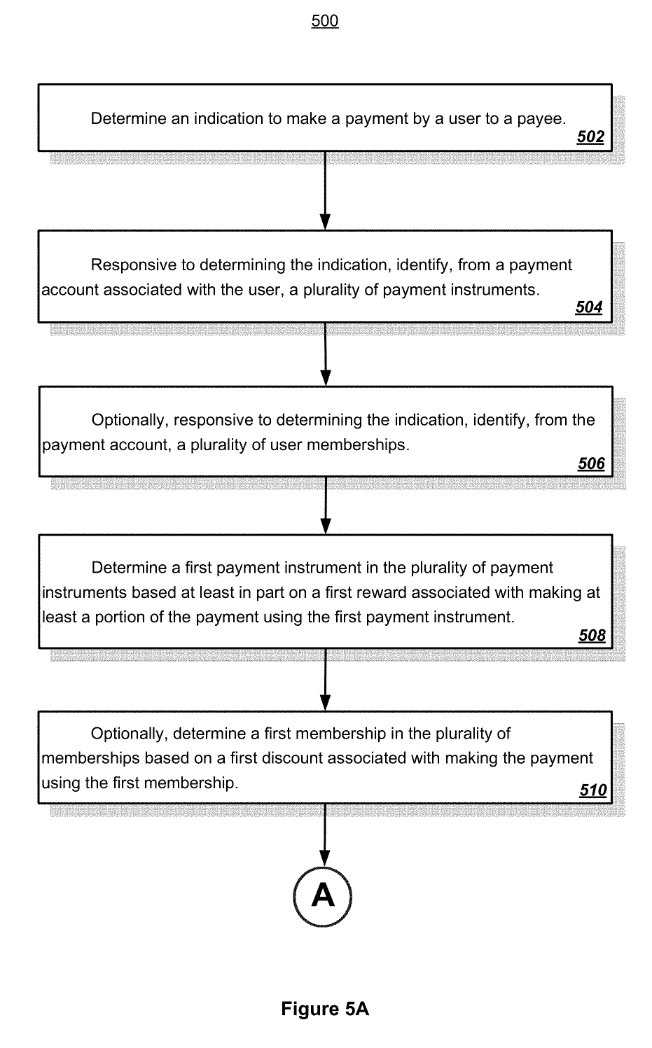

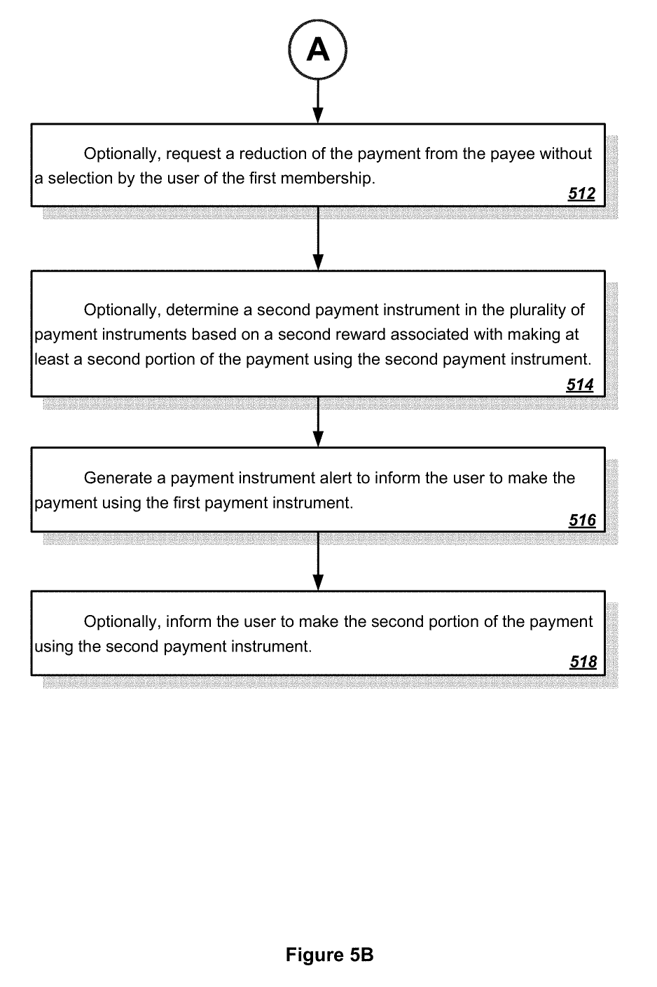

FIGS. 5A-5B are flow charts illustrating an embodiment of a method 500 for providing, conducting, or processing mobile transactions. The payment service system 106, for example, when programmed in accordance with the technologies described in the present disclosure, can perform the method 500. In some implementations, the method 500 includes determining (502) an indication to make a payment by a user to a payee, and the determination of the indication that a user is to make a payment may include detecting that the user is at a particular stage of an online transaction. For example, the indication may be that the user has completed a shipping address for an online order and is continuing to the next stage (e.g., payment) of the order process.

Determining an indication that a user is to make a payment to a payee may also include determining that the user is at a physical location of the payee and that a user device has initiated a particular communication with a payee device (e.g., a merchant device). For example, the payment service system may determine (e.g., through the payment application 152 installed on a user's smartphone), that a user is at a physical store of a merchant based on the user's smartphone communicating (e.g., directly with the payment service system or via the Internet) using WiFi signals that identify the merchant as the WiFi provider. For example, the header information of a WiFi data packet may include the metadata “Target Store #132” or the like, which may indicate that the user is at the physical location of a TARGET® store. In another example, the payment service system may determine that a user is at a physical store of a merchant based on a GPS component of the user's smartphone identifying the user's location as within a proximity (e.g., less than 3 feet) of the store location.

In an embodiment, after determining that the user is at a physical location of the merchant, the payment service system may deem a communication between a user device and a store device as an indication that a user is to make a payment. For example, a payment system may detect (e.g., through a hardware component or software package installed on a store register) an NFC signal between a user's smartphone and the store register and deem this NFC signal as an indication that the user is about to make a payment.

In some implementations, the method 500 further includes identifying (block 504), in response to determining the indication and from a payment account associated with the user, a plurality of payment instruments. For example, in response to determining that a user is about to make a payment (e.g., using the payment service system or a physical credit card), the payment service system may access a payment account of the user and determine which one or more payment instruments are available in the account.

In some implementations, the method 500 additionally includes determining (508) a first payment instrument in the plurality of payment instruments based at least in part on a first reward associated with making at least a portion of the payment using the first payment instrument. For example, as shown in FIG. 3, the payment service system may determine that using the Discover card ending in 3857 for a particular transaction can produce a $180.00 cash back. In another example, the payment service system may determine that using a checking account (as opposed to a credit card), a particular transaction with a particular merchant can produce a predefined amount of upfront saving (as opposed to cash back), e.g., because the merchant charges, for the same merchandise, a lower price for using a debit card and a higher price for using a credit card. In a further example, the payment service system may determine that using a check account (as opposed to a credit card), a particular transaction with a particular merchant can produce a predefined amount of upfront saving (as opposed to cash back), e.g., because the merchant (e.g., a gas station) charges a lower price for not using a credit card.

In some implementations, the payment service system may determine which payment instrument to suggest based on known customs or merchant policies. For example, certain brands of gas stations are known to either accept only debit cards or cash and not credit cards, or to charge a higher price for using a credit card and a lower price for using a debit card. In another example, certain restaurants are known to accept only certain types of credit cards. The payment service system may determine these customs from public sources (e.g., website of a certain restaurant) and/or from user feedback, and use that information for suggesting payment instruments using the payment application to make a payment to the payee.

In an embodiment, a payment instrument alert may be generated. For example, the method 500 may include generating (516) a payment instrument alert or notification to inform the user to make the payment using the first payment instrument. As discussed with reference to at least FIG. 2, the payment instrument alert may be a visual alert or a motion alert.

In an embodiment, an “auto-pay” feature may be provided. For example, the method 500 may include making, in response to determining the first payment instrument, the payment to the payee using the first payment instrument without a selection by the user of the first payment instrument.

In some embodiments, a “payment split” feature may also be provided (e.g., when making a payment with a single payment instrument does not produce an optimal reward for a user.) For example, the method 500 may include determining (514) a second payment instrument in the plurality of payment instruments based on a second reward associated with making at least a second portion of the payment using the second payment instrument; and informing (518) the user to make the second portion of the payment using the second payment instrument. In a specific example involving a single payment, credit card A may offer 20% cash back the first $100 and 1% cash back for the remaining amount; credit card B may offer 15% cash back for any payment. As such, when a user is making a payment of $300, using either the credit card A ($22 cash back) or the credit card B ($45) alone may not produce the most cash back ($50). In this example, the payment service system may determine to use (1) the credit card A to pay towards the first $100 of the $300 payment and (2) the credit card B towards the remaining $200, achieving the most cash back ($50) under the circumstances.

In some embodiments, the new technologies discussed above are advantageous not only because payments may be split onto multiple payment instruments to produce greater rewards relative to using any single payment instrument, but also because automatically suggesting two or more payment instruments to produce greater rewards for a user may reduce (1) repetitive and often inefficient user operations on the payment device, e.g., switching between different applications in an attempt to manually calculate reward amount, and (2) data communication overhead between a user device and a remote computer service that result from, for example, numerous database queries and query results analysis for data relating to reward calculations.

In an embodiment, a “user membership auto-detection” feature may be provided. For example, the payment service system may determine a user's membership using information stored on a user account (e.g., specific club membership number or user profile information such as age, employment history, or current occupation). The payment service system may then apply a determined membership to a payment when the membership can reduce upfront payment or increase cash back (e.g., when a user is a member (e.g., paid or unpaid) of a wholesale club, when a user is eligible for a discount from a merchant based on her employment status (e.g., a police offer, a fire fighter, an employee of a particular company), when a user is eligible for a discount based on her senior citizen status or veteran status, etc.) The method 500 may therefore include identifying (506) from the payment account, in response to determining the indication, a plurality of user memberships; determining (508) a first membership in the plurality of memberships based on a first discount associated with making the payment using the first membership; and requesting (512) a reduction of the payment from the payee without a selection by the user of the first membership.

In some implementations, a “payment restriction detection” feature may be provided. For example, the method 500 may include identifying, in response to determining the indication, a payment restriction associated with the payee; and determining the first payment instrument of the plurality of payment instruments based at least in part on the payment restriction. In a specific example, a payment service system may determine whether a particular payee imposes any limitations on what payment instruments are accepted (e.g., whether a gas station or a restaurant accepts credit cards for payments that are less than $20 dollars, whether a neighborhood grocery store accepts a particular type of credit card, etc.) and suggest payment instruments to the user in accordance with these limitations.

The method 500 may also include obtaining reward information associated with the plurality of payment instruments from a third party other than the user or the payee. For example, in some implementations, rewards for using a particular payment instruments may be determined from a third party source such as a website (not affiliated with the payee) that publishes deals or coupons, or a third party blog that publishes information on how to achieve more rewards (e.g., how to split a payment across different payment instruments or how to use multiple payment instruments in a particular sequence, e.g., credit card A before debit card B). The payment service system may process the information into payment rules, store them in a user account, and apply one or more payment rules when corresponding conditions are met.

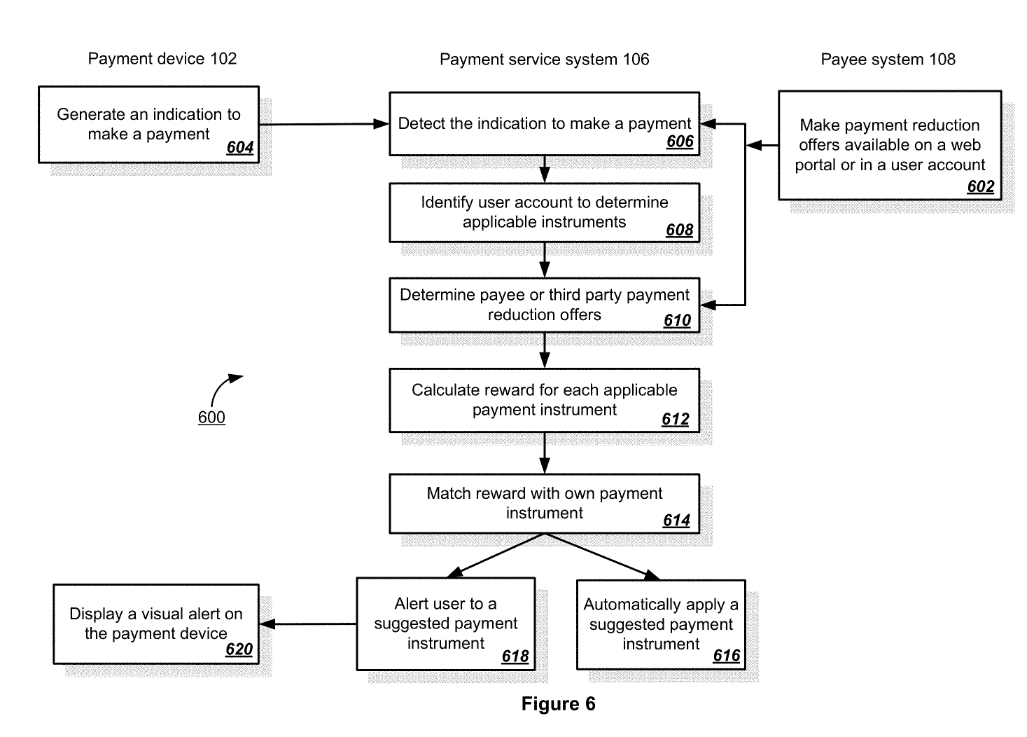

FIG. 6 is a flow chart illustrating an embodiment of a method 600 for providing, conducting, or processing mobile transactions. The payment service system 106 may perform the method 600 when programmed in accordance with the technologies described in the present disclosure. As shown in FIG. 6, a payee system may operate on a time schedule to make payment reduction offers (e.g., cash back offers or discounts) available either publicly or privately (e.g., at a web portal or in a particular user payment account managed by the payment service provider, respectively), and those payment reduction offers may be made available before a particular payment or during the payment process.

Responsive to a user action (e.g., invoking the payment application 152) or automatically, a payment device may generate (604) an indication to make a payment. The payment service provider may detect (606) the indication to make a payment and identify (608) payment instrument(s) stored in a payment account of the user and determine the payment instrument(s) applicable (e.g., a debit card, but not any credit cards) to the payment. Once applicable payment instrument(s) are determined, the payment service system 106 may determine whether any payment reduction offers by the payee (e.g., a store coupon) or by a third party (e.g., a manufacture discount mail-in-rebate offer or a credit card cash back offer) are available and can be applied to the payment. Based the availability of the payment reduction offers, the payment service system 106 may calculate (612) a reward for using each of the applicable payment instruments towards the payment.

In some implementations, the payment service system may offer its own payment instrument matching the reward offered by an applicable payment instrument. For example, after determining that using credit card C can produce a $20 cash back for a user, the payment service system may offer the user a line of credit with an equal or greater cash back to complete the payment. These new technologies may reduce communications overhead between an issuer of a payment instrument and a user device (e.g., starting a new communication session between a credit card issuer's data server and a user's smartphone) by enabling a payment based on existing data communications (e.g., an existing authenticated user session) between the payment service system and the user device. In some implementations, the payment service system 108 may alert (618) a user to a suggested payment instrument, e.g., by causing a visual alert to be displayed (620) on the payment device 102. In some implementation, the payment service system 108 may automatically apply (616) a payment instrument towards the payment, e.g., when the reward calculated exceeds a predefined user amount (e.g., $40). These new technologies may reduce user burden needed to complete a payment.

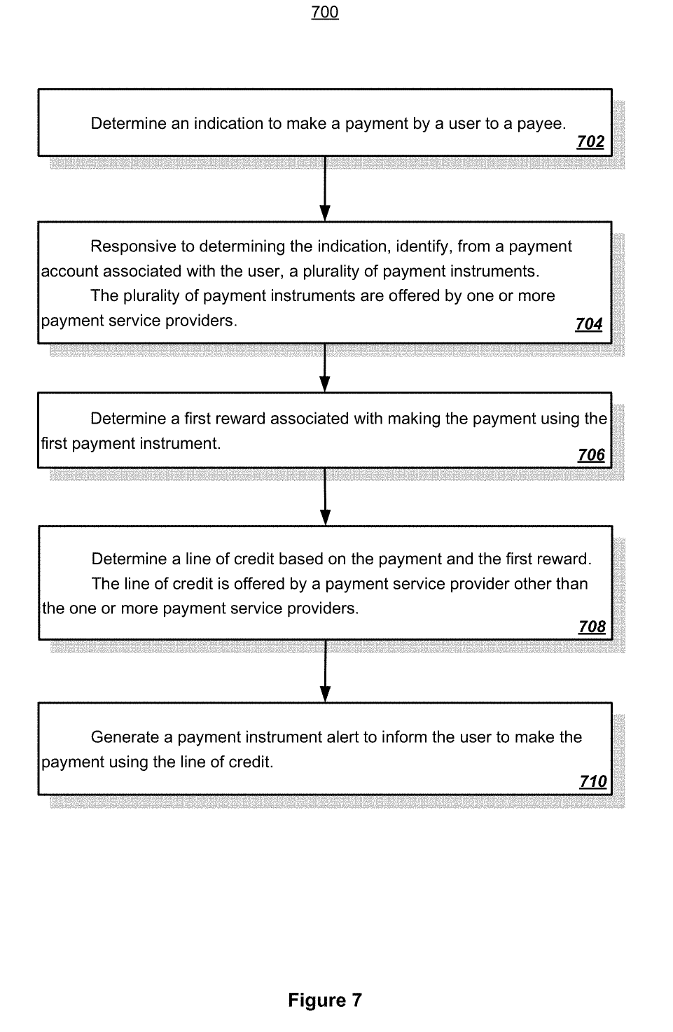

FIG. 7 is a flow chart illustrating an embodiment of a method 700 for providing, conducting, or processing mobile transactions. The payment service system 106 may perform the method 700 when programmed in accordance with the technologies described in the present disclosure. The method 700 includes determining (702) an indication to make a payment by a user to a payee and, in response, identifying (704) a plurality of payment instruments from a payment account associated with the user. The plurality of payment instruments may be offered by one or more payment service providers such as, for example, a bank, a credit card issuer, or a personal loan provider.

In an embodiment, the method 700 may also include determining (706) a first reward associated with making the payment using the first payment instrument. Based on the first reward, the method 700 may additionally include determining a line of credit based on the payment and the first reward. The line of credit may be offered by a payment service provider other than the one or more payment service providers. For example, the payment service system 108 may have a preferred provider (e.g., a particular credit card issuer) and may offer payment instrument provided through the preferred provider to match or exceed rewards offered by at least some of the existing payment instruments stored in a user payment account. In another example, the payment service system 108 may offer its own payment instrument (e.g. a line of credit) matching or exceeding rewards offered by at least some of the existing payment instruments stored in a user payment account.

The method 700 may include generating (710) a payment instrument alert to inform the user to make the payment using the line of credit. For example, after matching the cash back offered by the credit card D with a line of credit offered by the bank E, the payment service system may promote to the user the use of the line of credit offered by the bank E towards the payment.

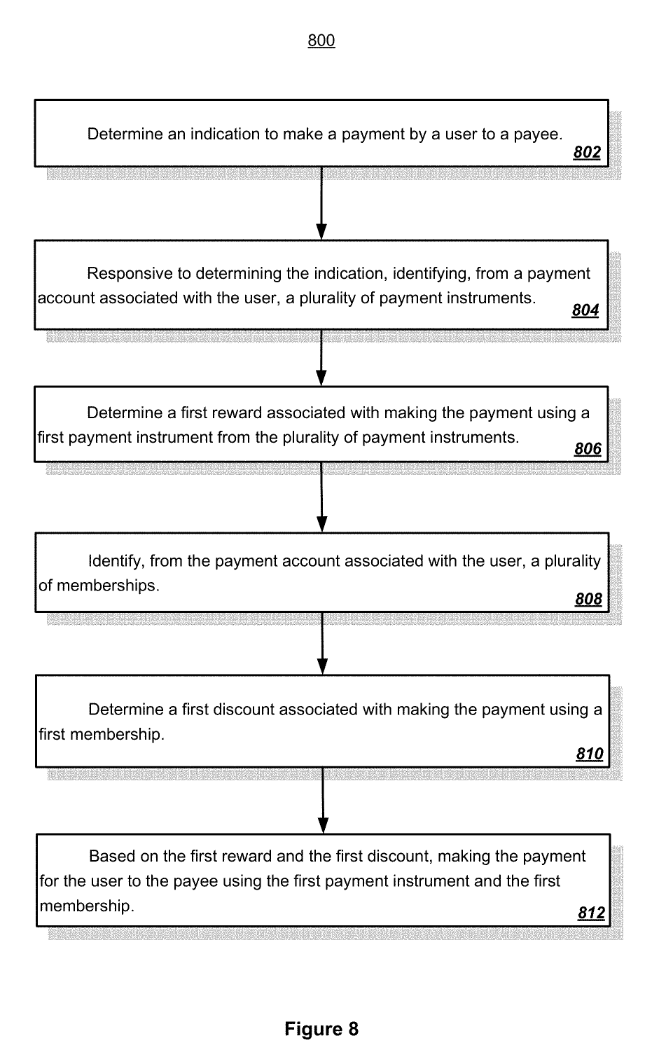

FIG. 8 is a flow chart illustrating an embodiment of a method 800 for providing, conducting, or processing mobile transactions. The payment service system 106 may perform the method 800 when programmed in accordance with the technologies described in the present disclosure. In some implementations, the method 800 includes determining (802) an indication to make a payment by a user to a payee and, response, identifying (804) a plurality of payment instruments from a payment account associated with the user.

The method 800 may further include determining (806) a first reward associated with making the payment using a first payment instrument from the plurality of payment instruments and identifying (808) a plurality of memberships from the payment account associated with the user. The method 800 may additionally include determining (810) a first discount associated with making the payment using a first membership; and based on the first reward and the first discount, making (812) the payment for the user to the payee using the first payment instrument and the first membership.

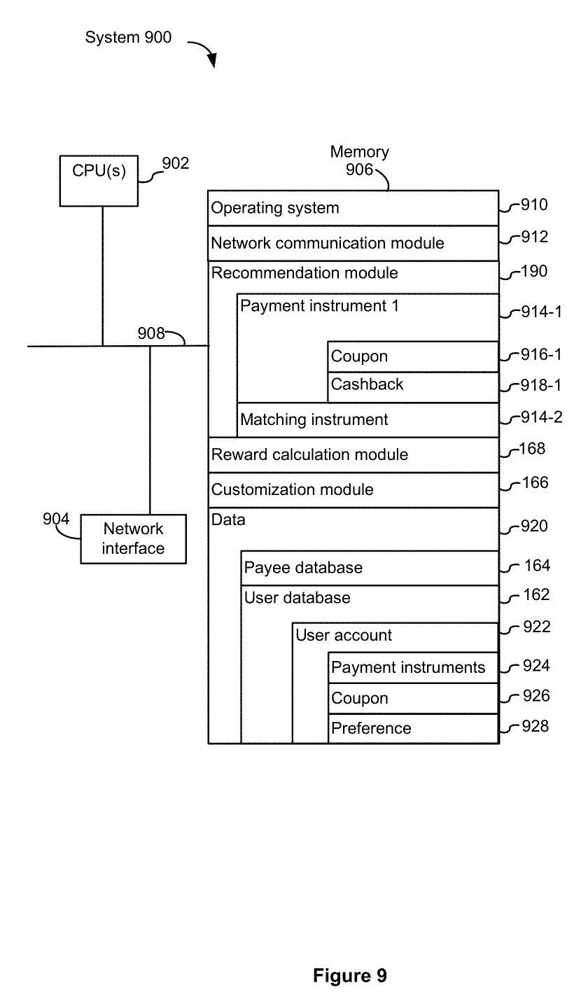

FIG. 9 is a schematic view illustrating an embodiment of a system 900, which can be the payment service system 108 shown in FIG. 1. The system 900 in some implementations includes one or more processing units CPU(s) 902 (also referred to as hardware processors), one or more network interfaces 904, a memory 906, and one or more communication buses 908 for interconnecting these components. The communication buses 908 optionally include circuitry (sometimes called a chipset) that interconnects and controls communications between system components. The memory 906 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 906 optionally includes one or more storage devices remotely located from the CPU(s) 902. The memory 906, or alternatively the non-volatile memory device(s) within the memory 906, comprises a non-transitory computer readable storage medium. In some implementations, the memory 906 or alternatively the non-transitory computer readable storage medium stores the following programs, modules and data structures, or a subset thereof:
an operating system 910, which includes procedures for handling various basic system services and for performing hardware dependent tasks;
a network communication module (or instructions) 912 for connecting the device 102 with other devices (e.g., the payment service system 106 and the payee system 108) via one or more network interfaces 804;
a recommendation module 190 for suggesting to a user or for automatically selecting without user efforts one or more payment instruments for application to a payment in accordance with user preferences stored in the customization module 166; a suggested or selected payment instrument may be an existing payment instrument 914-1 (with the corresponding applicable coupon 916-1 or the estimated cash back 918-1) or a matching payment instrument 914-2 (e.g., provided by a preferred payment service system);
a reward calculation module 168 for determining reward (e.g., cash backs or loyalty program points) for making at least a portion of a payment with a particular payment instrument or with a payment reduction offer, or both;
a customization module 166 for providing one or more user preferences of payment instruments; and
data 920 stored on the system 900, which may include:
   a payee database 164, which may store information identifying one or more payees (e.g., merchant names) and payment reduction offers available from the one or more payees; and
   a user database 162, which may store one or more user payment accounts 922, a user payment account 922 may include:
      two or more payment instruments 924;
      one or more payment reduction offers (e.g., coupons) 926; and
      one or more user preferences 928.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 906 optionally stores a subset of the modules and data structures identified above. Furthermore, the memory 906 may store additional modules and data structures not described above.

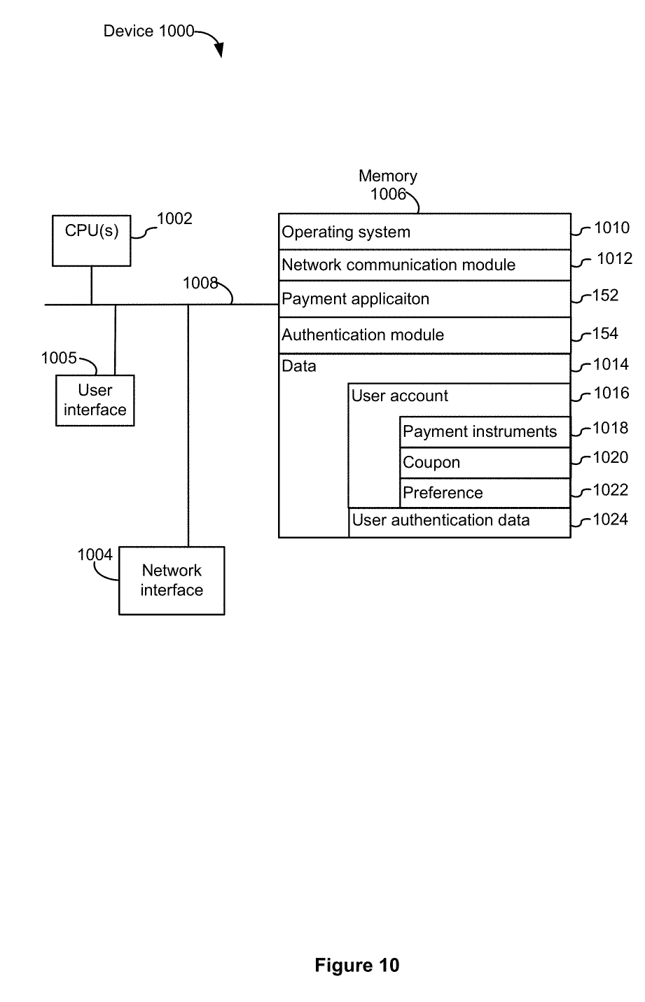

FIG. 10 is a schematic view illustrating an embodiment of a device 1000, which can be the device 102 shown in FIG. 1. The device 1000 in some implementations includes one or more processing units CPU(s) 1002 (also referred to as hardware processors), one or more network interfaces 1004, a user interface 1005, a memory 1006, and one or more communication buses 1008 for interconnecting these components. The communication buses 1008 optionally include circuitry (sometimes called a chipset) that interconnects and controls communications between system components. The memory 1006 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 1006 optionally includes one or more storage devices remotely located from the CPU(s) 1002. The memory 1006, or alternatively the non-volatile memory device(s) within the memory 1006, comprises a non-transitory computer readable storage medium. In some implementations, the memory 1006 or alternatively the non-transitory computer readable storage medium stores the following programs, modules and data structures, or a subset thereof:
an operating system 1010, which includes procedures for handling various basic system services and for performing hardware dependent tasks;
a network communication module (or instructions) 1012 for connecting the device 1000 with other devices (e.g., the payment service system 106 and the payee system 108) via one or more network interfaces 1004 (wired or wireless) or via the communication network 104 (FIG. 1);
a payment application 152 for applying payment instruments selected by a user or by the payment service system 108 to a payment;
an authentication module 154 for authenticating a user for making a payment using the device 1000; and
data 1014 stored on the device 100, which may include:
   a user account 1016, which may include:
      two or more payment instruments 1018;
      one or more payment reduction offers (e.g., coupons) 1020; and
      one or more user preferences 1022; and
   user authentication data 1024 which identify previously accepted user credentials, e.g., a password, an audio fingerprint, a user gesture, a user finger, or facial recognition data.

The device 1000 may also include a user interface 1005 for a user to interact with the device 1000 though a user input device (e.g., a keyboard, a mouse, a touchpad, a track pad, and a touch screen). The device 100 may further include a location determination component (e.g., a Global Positioning System (GPS) device and a cell tower triangulation device).

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 1006 optionally stores a subset of the modules and data structures identified above. Furthermore, the memory 1006 may store additional modules and data structures not described above.

Although FIGS. 9 and 10 show a “system 900” and a “device 1000,” respectively, FIGS. 9 and 10 are intended more as functional description of the various features which may be present in computer systems than as a structural schematic of the implementations described herein. In practice, and as recognized by those of ordinary skill in the art, items shown separately could be combined and some items could be separated.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and users; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory; and
one or more hardware processors coupled to the non-transitory memory and configured to read instructions from the non-transitory memory to cause the system to perform operations comprising:
determining, through an network from a user device, an indication to make a payment from a user to a payee;
responsive to determining the indication, identifying, from a payment account associated with the user, a plurality of payment instruments;
determining a first payment instrument from the plurality of payment instruments that provides a first reward associated with making at least a portion of the payment using the first payment instrument;
generating a payment instrument alert that is configured to inform the user of the first reward associated with the first payment instrument; and
providing, through the network for display on the user device, the payment instrument alert.

2. The system of claim 1, wherein the operations further comprise:
responsive to determining the first instrument, making the payment to the payee using the first payment instrument without a selection by the user of the first payment instrument.

3. The system of claim 1, wherein the operations further comprise:
responsive to determining the indication, identifying plurality of user memberships from the payment account of the user;
determining a first membership in the plurality of memberships based on a first discount associated with making the payment using the first membership; and
requesting a reduction of the payment to the payee according to the first membership without a selection by the user of the first membership.

4. The system of claim 1, wherein the operations further comprise:
determining a second payment instrument from the plurality of payment instruments that provides a second reward associated with making at least a second portion of the payment using the second payment instrument; and
generating the payment instrument alert that is configured to inform the user of the second reward associated with the second payment instrument.

5. The system of claim 1, wherein the operations further comprise:
responsive to determining the indication, identifying a payment restriction associated with the payee; and
determining the first payment instrument in the plurality of payment instruments based at least in part on the payment restriction.

6. The system of claim 1, wherein the operations further comprise:
obtaining reward information associated with the plurality of payment instruments from a third party other than the user or the payee.

7. The system of claim 1, wherein determining the indication to make the payment comprises detecting the user is at a particular stage of an online transaction.

8. The system of claim 1, wherein determining the indication to make the payment comprises detecting a communication between a user device associated with the user and a payee device associated with the payee at a physical location of the payee.

9. The system of claim 1, wherein generating the payment instrument alert comprises generating a visual alert on a display of a user device associated with the user.

10. The system of claim 1, wherein the operations further comprise:
determining an identity of the payee based on a data communication between the payee and the user, the data communication being other than the indication to make the payment.

11. A method, comprising:
determining, through an network from a user device, an indication to make a payment from a user to a payee;
responsive to determining the indication, identifying, from a payment account associated with the user, a plurality of payment instruments;
analyzing the plurality of payment instruments to determine a first payment instrument that provides a first reward associated with making at least a portion of the payment using the first payment instrument;
generating a payment instrument alert that is configured to inform the user of the first reward associated with the first payment instrument; and
providing, through the network for display on the user device, the payment instrument alert.

12. The method of claim 11, further comprising:
responsive to determining the first instrument, making the payment to the payee using the first payment instrument without a selection by the user of the first payment instrument.

13. The method of claim 11, further comprising:
responsive to determining the indication, identifying plurality of user memberships from the payment account of the user;
determining a first membership in the plurality of memberships based on a first discount associated with making the payment using the first membership; and
requesting a reduction of the payment to the payee according to the first membership without a selection by the user of the first membership.

14. The method of claim 11, further comprising:
analyzing the plurality of payment instruments to determine a second payment instrument that provides a second reward associated with making at least a second portion of the payment using the second payment instrument; and
generating the payment instrument alert that is configured to inform the user of the second reward associated with the second payment instrument.

15. The method of claim 11, further comprising:
responsive to determining the indication, identifying a payment restriction associated with the payee; and
determining the first payment instrument in the plurality of payment instruments based at least in part on the payment restriction.

16. A non-transitory machine-readable medium having stored thereon machine-readable instructions executable to cause a machine to perform operations comprising:
determining, through an network from a user device, an indication to make a payment from a user to a payee;
responsive to determining the indication, identifying, from a payment account associated with the user, a plurality of payment instruments;
determining a first payment instrument from the plurality of payment instruments that provides a first reward associated with making at least a portion of the payment using the first payment instrument;
generating a payment instrument alert that is configured to inform the user of the first reward associated with the first payment instrument; and
providing, through the network for display on the user device, the payment instrument alert.

17. The non-transitory machine-readable medium of claim 16, wherein the operations further comprise:
responsive to determining the first instrument, making the payment to the payee using the first payment instrument without a selection by the user of the first payment instrument.

18. The non-transitory machine-readable medium of claim 16, wherein the operations further comprise:
responsive to determining the indication, identifying plurality of user memberships from the payment account of the user;
determining a first membership in the plurality of memberships based on a first discount associated with making the payment using the first membership; and
requesting a reduction of the payment to the payee according to the first membership without a selection by the user of the first membership.

19. The non-transitory machine-readable medium of claim 16, wherein the operations further comprise:
determining a second payment instrument from the plurality of payment instruments that provides a second reward associated with making at least a second portion of the payment using the second payment instrument; and
generating the payment instrument alert that is configured to inform the user of the second reward associated with the second payment instrument.

20. The non-transitory machine-readable medium of claim 16, wherein the operations further comprise:
responsive to determining the indication, identifying a payment restriction associated with the payee; and
determining the first payment instrument in the plurality of payment instruments based at least in part on the payment restriction.
